(19) United States
(12) Patent Application Publication
(10) Pub. No.: US 2019/0141544 A1
(43) Pub. Date: May 9, 2019

(54) Intelligent Network Routing

(71) Applicant: T-Mobile USA, Inc., Bellevue, WA (US)

(72) Inventors: Yasmin Karimli, Kirkland, WA (US); Ming Shan Kwok, Seattle, WA (US)

(21) Appl. No.: 15/805,748

(22) Filed: Nov. 7, 2017

(51) Int. Cl. H04W 24/02; H04W 76/02; H04W 28/02; H04W 28/08

(52) U.S. Cl. CPC H04W 24/02; H04W 76/025; H04W 88/06; H04W 28/08; H04W 28/0268

(57) ABSTRACT

Intelligent network routing is described. Server(s) can send, to a device utilizing a non-cellular network, a request for first information associated with a first radio associated with non-cellular technology and second information associated with a second radio associated with cellular technology. Responsive to sending the request, the server(s) can receive, from the device, the first information and the second information. The server(s) can determine, based at least in part on the first information and the second information, to change a state of the first radio and/or the second radio and can send, to the device, an instruction to affect the change to the state of the first radio and/or the second radio. In some examples, the server(s) can determine to route the device to the cellular network (e.g., changing the state of the second radio to a connected state) to provide an improved user experience.

### BACKGROUND

Mobile devices can communicate with other mobile device(s), server(s), etc. using various network technologies. For instance, mobile devices can communicate via cellular networks (e.g., Global System for Mobile Communications (GSM), Universal Mobile Telecommunications System (UMTS), Long-term Evolution (LTE), etc.) and/or non-cellular networks (e.g., Wi-Fi, WIMAX, etc.). Often, cellular networks and/or non-cellular networks can become overpopulated and/or can have poor network quality, causing poor user experience.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an environment for determining whether to route a device from a non-cellular network to a cellular network.

FIG. 2 illustrates an environment for intelligent network routing.

FIG. 3 illustrates an example process for determining whether a network change is warranted based at least in part on information associated with one or more networks.

FIG. 4 illustrates an example process for determining whether to disable a radio based at least in part on information associated with one or more networks.

FIG. 5 illustrates an example process for ranking two or more networks based at least in part on information associated with the two or more networks.

FIG. 6 illustrates an example process for changing a state of one or more radios associated with a device.

FIG. 7 illustrates an example process for determining whether a network change is warranted based at least in part on information associated with one or more networks.

### DETAILED DESCRIPTION

This disclosure describes intelligent network routing. As described above, mobile devices can communicate with other mobile device(s), server(s), etc. using various network technologies. For instance, mobile devices can communicate via cellular networks (e.g., Global System for Mobile Communications (GSM), Universal Mobile Telecommunications System (UMTS), Long-term Evolution (LTE), 5^{th} generation (5G), etc.) and/or non-cellular networks (e.g., Wi-Fi, WIMAX, etc.). Often, cellular networks and/or non-cellular networks can become overpopulated and/or can have poor network quality, causing poor user experience. Techniques described herein are directed to leveraging information determined for various radios associated with a device to determine whether to route the device from a non-cellular network to a cellular network to optimize user experience.

In an example, one or more servers associated with a service provider can send a request for information associated with a cellular radio and a non-cellular radio (e.g., a Wi-Fi radio) of a device. An application associated with the device can determine information associated with one or more cellular networks from the cellular radio. Such information can include an identification of one or more cellular technologies (e.g., GSM, UMTS, LTE, 5G, etc.) that are available via the one or more cellular networks, a signal-to-interference-plus-noise ratio associated with each of the one or more cellular networks, a latency associated with each of the one or more cellular networks, a packet-loss rate associated with each of the one or more cellular networks, a latency variance associated with each of the one or more cellular networks, etc. The application can provision such information to the one or more servers responsive to the request. In some examples, the one or more servers can determine a quality of each of the cellular networks, which can be represented by a value or other indicator, based on the information associated with the one or more cellular networks.

Additionally and/or alternatively, the application can determine information associated with one or more non-cellular networks from the non-cellular radio. Such information can include identities (e.g., SSID) of one or more non-cellular networks, backhaul associated with each of the one or more non-cellular networks, bandwidth associated with each of the one or more non-cellular networks, or network quality rating associated with each of the one or more non-cellular networks. The application can provision such information to the one or more servers responsive to the request. In some examples, the one or more servers can determine a quality of each of the non-cellular networks, which can be represented by a value or other indicator, based on the information associated with the one or more non-cellular networks.

In at least one example, the one or more servers can compare the quality of a network to which a device is connected, with determined qualities of one or more other networks. For instance, if a device is connected to a non-cellular network (e.g., a Wi-Fi network), the one or more servers can compare the quality of the non-cellular network with qualities of other networks. In some examples, a cellular network can be determined to be of higher quality than the non-cellular network. In such an example, based at least in part on determining that the cellular network has a higher quality than the non-cellular network, such that the cellular network is likely to provide a better user experience to a user of the device, the one or more servers can send an instruction to the device to cause the device to change the state of the cellular radio (to a connected state) and the state of the non-cellular radio (to a disconnected state). That is, the instruction can cause the device to route future data transmissions through the cellular network instead of the non-cellular network. As a result, the application on the device can modify the state of the cellular radio and the non-cellular radio to optimize user experience.

While the example above is directed to routing a device from a non-cellular network to a cellular network, similar techniques can be used to route a device from a cellular network to a non-cellular network. That is, the one or more servers can determine that a non-cellular network is likely to provide a better user experience than a cellular network and can consequently route communications through the non-cellular network via affecting a change to states of the cellular radio and non-cellular radio. Additionally, techniques described herein can be used to determine when to turn off a radio (e.g., disable the radio).

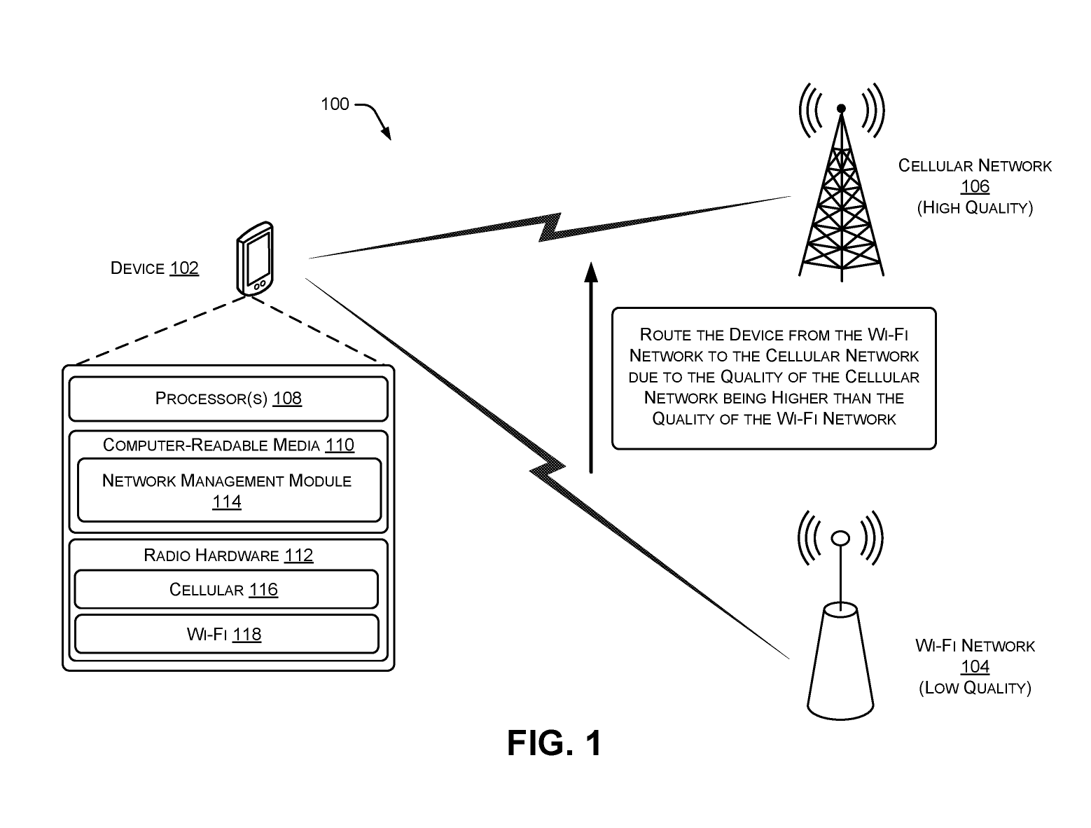

FIG. 1 illustrates an environment 100 for determining whether to route a device from a non-cellular network to a cellular network. In at least one example, the environment 100 can include a device 102 that is connected (wirelessly) to a non-cellular network, such as Wi-Fi network 104. While the non-cellular network is shown as a Wi-Fi network, in an alternative example the device 102 can be connected to a different type of non-cellular network (e.g., WIMAX, etc.).

In at least one example, the device 102 can correspond to user equipment (UE) including, but not limited to, a smart phone, a personal digital assistant, a netbook, a laptop computer, a smart appliance, and/or another electronic device that is capable of transmitting or receiving audio, video, and/or data via the network(s) (e.g., the Wi-Fi network 104 or a cellular network 106). In at least one example, the device 102 can include processor(s) 108, computer-readable media 110, and radio hardware 112. The processor(s) 108 can represent, for example, a central processing unit (CPU)-type processing unit, a graphics processing unit (GPU)-type processing unit, a Field-Programmable Gate Array (FPGA), another class of Digital Signal Processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc. In at least one example, an accelerator can represent a hybrid device, such as one from ZYLEX or ALTERA that includes a CPU course embedded in an FPGA fabric. In various embodiments, the processor(s) 108 can execute one or more modules and/or processes to cause the device 102 to perform a variety of functionalities, as set forth above and explained in further detail in the following disclosure. Additionally, each of the processor(s) 108 can possess its own local memory, which also can store program modules, program data, and/or one or more operating systems.

Depending on the exact configuration and type of the device 102, the computer-readable media 110, can include computer storage media and/or communication media.

Computer storage media can include volatile memory, nonvolatile memory, and/or other persistent and/or auxiliary computer storage media, removable and non-removable computer storage media implemented in any method or technology for storage of information such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In at least one example, the computer storage media can include non-transitory computer-readable media. Non-transitory computer-readable media can include volatile and nonvolatile, removable and non-removable tangible, physical media implemented in technology for storage of information, such as computer readable instructions, data structures, program modules, or other data. The computer-readable media 110 is an example of non-transitory computer-readable media. Non-transitory computer-readable media include, but are not limited to, RAM, ROM, EEPROM, flash memory or other memory technology, CD-ROM, DVDs or other optical storage, magnetic cassettes, magnetic tape, magnetic disk storage or other magnetic storage devices, or any other tangible, physical medium which can be used to store the desired information and which can be accessed by the device 102. Any such non-transitory computer-readable media can be part of the device 102.

In contrast, communication media includes computer readable instructions, data structures, program modules, or other data in a modulated data signal, such as a carrier wave, or other transmission mechanism. As defined herein, computer storage media does not include communication media.

The computer-readable media 110 can include one or more modules and data structures including, for example, a network management module 114. The one or more modules and data structures can be in the form of stand-alone applications, productivity applications, an operating system component, or any other application or software module configured to facilitate intelligent network routing, as described herein.

The network management module 114 can be configured to manage network connections on behalf of the device 102. In some examples, the network management module 114 can effectuate changes to state(s) of radio hardware 112 associated with the device 102. In at least one example, the network management module 114 can receive a request from one or more servers (not picture in FIG. 1) for information associated with networks that are available to the device 102. Responsive to receiving a request, the network management module 114 can request such information from radio(s) associated with the radio hardware 112. The network management module 114 can receive the information from the radio(s) and can send such information to the one or more servers. Responsive to sending the information to the one or more servers, the network management module 114 can receive an instruction from the one or more servers. The instruction can direct the network management module 114 to change the state of one or more of the radio(s) associated with the radio hardware 112 such to cause the device 102 to communicate via the network that is likely to provide the best user experience. The network management module 114 can effectuate the change(s) to the state(s) of the radio(s) based on the instruction.

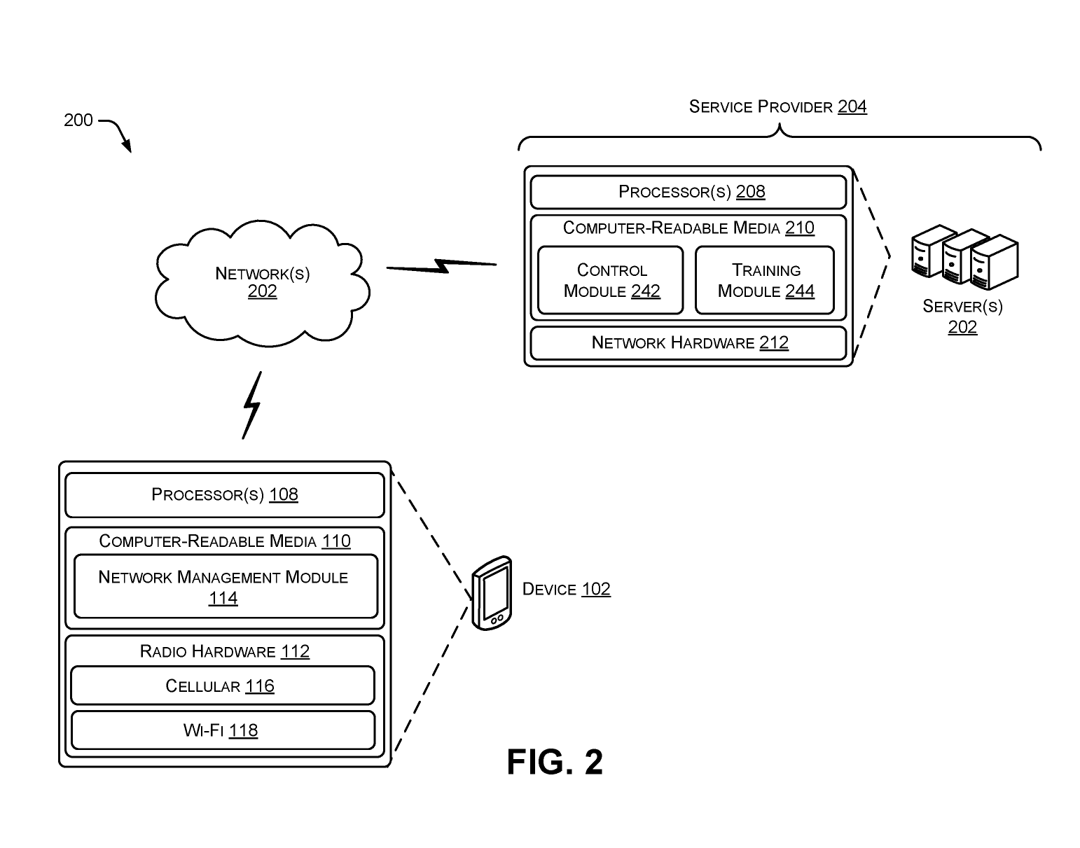

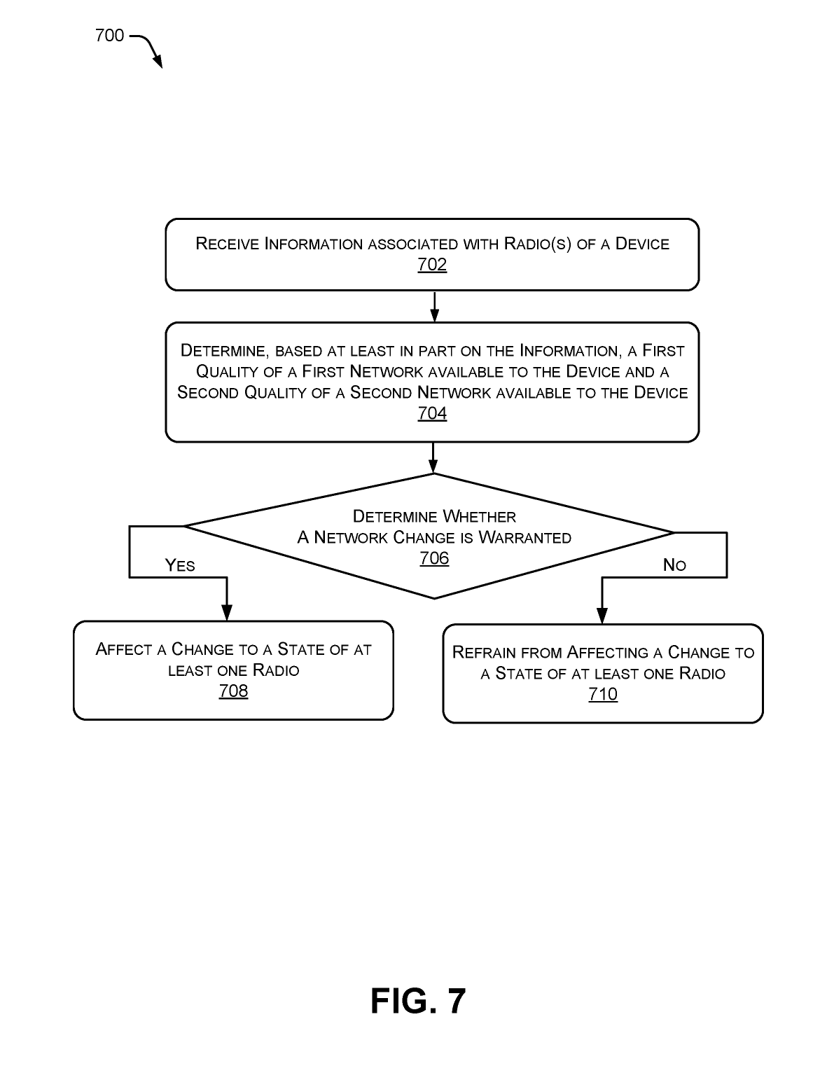

In at least one example, the network management module 114 can perform same and/or similar functions as one or more modules associated with the one or more servers, as described below with reference to FIGS. 2 and 7. That is, in some examples, the network management module 114 can determine relative qualities of networks that are available to the device 102 and determine to which network the device 102 should be connected to optimize user experience.

The radio hardware 112 provides wireless UE capabilities, such as connecting to a base station associated with the cellular network 106, the Wi-Fi network 104, or other wireless networks. The radio hardware 112 can include or be incorporated into processors, ASICs, programmable circuits such as FPGAs, or in other ways. In at least one example, the radio hardware 112 can include a cellular radio 116 and a Wi-Fi radio 118.

The cellular radio 116 can provide cellular functionalities for the device 102. In at least one example, the cellular radio 116 may be a radio that utilizes licensed spectrum. In at least one example, the cellular radio 116 can scan for one or more cellular networks that are within range of the device 102. In some examples, the cellular radio 116 can determine information associated with the one or more cellular networks. For instance, such information can include an identification of one or more cellular technologies (e.g., GSM, UMTS, LTE, 5G, etc.) that are available via the one or more cellular networks, a signal-to-interference-plus-noise ratio associated with each of the one or more cellular networks, a latency associated with each of the one or more cellular networks, a packet-loss rate associated with each of the one or more cellular networks, a latency variance associated with each of the one or more cellular networks, etc. In some examples, the cellular radio 116 can scan for one or more cellular networks and/or determine such information associated with the one or more cellular networks at a particular frequency, after a lapse of a predetermined period of time, responsive to a request (e.g., from the network management module 114), etc. The cellular radio 116 can provide such information to the network management module 114 as it is determined or in batches.

The Wi-Fi radio 118 can provide Wi-Fi functionality for the device 102. In at least one example, the Wi-Fi radio 118, which can be an alternative type of non-cellular radio in an alternative example, may be a radio that uses unlicensed spectrum. In at least one example, the Wi-Fi radio 118 can scan for one or more Wi-Fi networks (e.g., hotspots) that are within range of the device 102. In some examples, the Wi-Fi radio 118 can determine information associated with the one or more Wi-Fi networks. For instance, such information can include identities (e.g., SSID) of one or more Wi-Fi networks, backhaul associated with each of the one or more Wi-Fi networks, bandwidth associated with each of the one or more Wi-Fi networks, bandwidth associated with each of the one or more Wi-Fi networks, or network quality rating associated with each of the one or more Wi-Fi networks. In some examples, the cellular radio 116 can scan for one or more Wi-Fi networks at a particular frequency, after a lapse of a predetermined period of time, responsive to a request (e.g., from the network management module 114), etc. The Wi-Fi radio 118 can provide such information to the network management module 114 as it is determined or in batches.

The radios (e.g., cellular radio 116 and/or Wi-Fi radio 118) can be associated with different states. As described herein, a radio can be in a connected state, wherein the radio is connected to a corresponding network and capable of transmitting data via the corresponding network. For instance, when the cellular radio 116 is in a connected state, the device 102 can transmit data via the cellular network 106 and when the Wi-Fi radio 118 is in a connected state, the device 102 can transmit data via the Wi-Fi network 104.

Alternatively, a radio can be in a disconnected state, wherein the radio is not connected to a corresponding network. A radio in a disconnected state can gather information associated with network(s) that are within range of the radio, but may not send and/or receive data. For instance, when the cellular radio 116 is in a disconnected state, the device 102 may not transmit data via the cellular network 106, but may scan for available cellular network(s) and/or determine information associated with such cellular network(s). Or, when the Wi-Fi radio 118 is in a disconnected state, the device 102 may not transmit data via the Wi-Fi network 104, but may scan for available Wi-Fi network(s) and/or determine information associated with such Wi-Fi network(s).

In some examples, a radio can be in an enabled state. When a radio is in an enabled state it can additionally be in a connected state or disconnected state. Alternatively, in other examples, a radio can be in a disabled state. A radio in a disabled state may not gather information associated with network(s) that are within range of the radio (e.g., the radio is “off”). In at least one example, a radio can receive a notification (e.g., from the network management module 114) to change from a disabled state to an enabled state, which can cause the radio to change to the enabled state and enable the radio to gather information associated with network(s) that are within range of the radio.

As illustrated in FIG. 1, Wi-Fi radio 118 can be in a connected state such that the device 102 is sending and/or receiving data via the Wi-Fi network 104. Often, devices (e.g., device 102) will connect to a Wi-Fi network 104 to mitigate the amount of data consumed via the device 102 (e.g., to reduce fees, prolong battery life, etc.). In at least one example, based on information associated with the cellular network 106 and the Wi-Fi network 104, the cellular network 106 can be of better quality than the Wi-Fi network 104. That is, the information determined by the cellular radio 116 and/or the Wi-Fi radio 118 can indicate that the cellular network 106 will provide a better user experience for the device 102.

Accordingly, the network management module 114 can receive an instruction to change the state of the Wi-Fi radio 118 from the connected state to a disconnected state such that the device 102 is no longer connected to the Wi-Fi network 104. As such, the network management module 114 can effectuate a change to the state of the Wi-Fi radio 118. Additionally, the network management module 114 can receive an instruction to change the state of the cellular radio 116 from a disconnected state to a connected state such that the device 102 is connected to the cellular network 106. As such, the network management module 114 can effectuate a change to the state of the cellular radio 116. Accordingly, future data transmissions can be sent and/or received via the cellular network 106 instead of the Wi-Fi network 104 to optimize the user experience for the device 102. In at least one example, the routing of data transmissions from the Wi-Fi network 104 to the cellular network 106 can be done automatically, without any input from a user of the device 102. That is, the network management module 114 can effectuate the change(s) to the state(s) of the radio(s) without any input from a user of the device 102.

FIG. 2 illustrates an environment 200 for facilitating intelligent network routing. As illustrated, the environment 200 includes the device 102, as described above with reference to FIG. 1. The device 102 can communicate with one or more servers 202 of a service provider 204 via one or more networks 206. The network(s) 206 can include cellular network(s) (e.g., cellular network 106), non-cellular network(s) (e.g., Wi-Fi network 104), etc.

The server(s) 202 can be any type of server, such as a network-accessible server. In some examples, the server(s) 202 can be stand-alone computing systems, distributed-computing systems, networked-computing systems, etc. For instance, in at least one example, one or more of the functionalities described herein as being performed by the server(s) can be performed by a single device or multiple devices. In some examples, one or more of the functionalities described herein can be performed by the device 102 instead of, or in addition to, the server(s) 202.

In various examples, each of the server(s) 202 can be associated with one or more processors 208, computer-readable media 210, and network hardware 212. The processor(s) 208 can have the same and/or similar structure and/or function as the processor(s) 108, described above.

Depending on the exact configuration and type of the server(s) 202, the computer-readable media 210 can include computer storage media and/or communication media. The computer-readable media 210 can have the same and/or similar structure and/or function as the computer-readable media 110, described above. The computer-readable media 210 can include one or more modules and data structures including, for example, a control module 242 and a training module 244. The one or more modules and data structures can be in the form of stand-alone applications, productivity applications, an operating system component, or any other application or software module for facilitating intelligent network routing, as described herein.

The control module 242 can send requests to devices, such as device 102. In at least one example, the control module 242 can send a request for information associated with network(s) that are within range of the device 102. A network can be within range of the device 102 if the device 102 can access the network. In some examples, the control module 242 can send requests at a particular (configurable) frequency, after the lapse of a predetermined (configurable) amount of time, after an occurrence of an event, etc. In some examples, an event can correspond to a significant change in a characteristic of a network. For instance, as a non-limiting example, a change in signal strength of a network that exceeds a threshold in a predetermined period of time (e.g., fast degradation of network signal strength) can be an event. Or, in an additional and/or alternative non-limiting example, congestion of a network that meets or exceeds a threshold can be an event. Further, in yet another non-limiting example, a change in a geolocation of a device (e.g., device 102) can be an event. Additional and/or alternative events can be imagined.

The control module 242 can receive information indicative of networks that are within range of the device 102. In some examples, the control module 242 can receive such information responsive to sending a request. In other examples, the control module 242 can receive such information at a particular frequency, after a lapse in a predetermined amount of time, etc. Such information can include an identification of one or more cellular technologies (e.g., GSM, UMTS, LTE, 5G, etc.) that are available via one or more cellular networks, a signal-to-interference-plus-noise ratio associated with each of the one or more cellular networks, a latency associated with each of the one or more cellular networks, a packet-loss rate associated with each of the one or more cellular networks, a latency variance associated with each of the one or more cellular networks, etc. Additionally and/or alternatively, such information can include identities (e.g., SSID) of one or more non-cellular networks, backhaul associated with each of the one or more non-cellular networks, bandwidth associated with each of the one or more non-cellular networks, or network quality rating associated with each of the one or more non-cellular networks.

Based on the information, the control module 242 can determine a quality associated with each network that is within range of the device 102. In some examples, the control module 242 can determine a value (or other indicator) that is representative of the quality of each network. For instance, a network that is determined to be of high quality—such to provide a positive user experience—can be associated with a value close to one, and a network that is determined to be of low quality—such to provide a negative user experience—can be associated with a value close to zero. While a scale of zero to one is used here, any scale, set of values, etc. can be used to represent a quality of a network. In at least one example, the control module 242 can compare networks and rank two or more networks based on corresponding quality. For instance, if the control module 242 determines that a cellular network is associated with a higher quality than a non-cellular network, the cellular network can be ranked higher than the non-cellular network. Or, if a non-cellular network is determined to be associated with a higher quality than a cellular network, the non-cellular network can be ranked higher than the cellular network.

In some examples, the control module 242 can access additional information associated with the network(s) 202 that is not available to the device 102. For instance, the control module 242 can access data indicative of rate plan(s) associated with the device 102 (e.g., associated with a subscriber account for receiving services from the service provider 204), congestion of the network(s) 202, prioritization policies set by the network(s) 202, etc. In such examples, the control module 242 can determine which network to connect the device 102 based at least in part on the information received from the device 102 and/or the additional information. In a non-limiting example, the control module 242 can determine that a device that is connected to a non-cellular network determined to be of a moderate quality (e.g., having a quality value between a threshold indicating high quality and a threshold indicating low quality) should stay connected to such a network if switching to a cellular network would cause a significant expense for a subscriber and/or if the cellular network is congested, despite the cellular network having been determined to be of high (or higher) quality (e.g., having a quality value above a threshold).

In at least one example, the control module 242 can utilize a data model, trained by a machine learning mechanism, to determine which network to route the device 102. In at least one example, the training module 244 can train the data model. For instance, the training module 244 can utilize a machine learning mechanism to build and/or modify a data model from example inputs that can be utilized to make predictions or decisions with regard to which network the control module 242 should route the device 102. In some examples, the output of the data model can be a ranking of two or more networks, the highest-ranking network representing the network to which the control module 242 should route the device 102. In such an example, the training module 244 can train the data model using supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc. In such examples, the machine learning mechanism can train the data model based on training data that includes information associated with network(s) that were available for a device at a particular time, information indicating which network a user connected to, and/or feedback data regarding how a user responded to a previous recommendation (e.g., did the device remain connected to the recommended network, or did the user override the recommended network for a different connection), etc.

Based on determining which network to connect the device 102, the control module 242 can generate an instruction to instruct the device 102 to change the state of at least one radio (e.g., cellular radio 116 and/or Wi-Fi radio 118). The control module 242 can send the instruction to the device 102 to effectuate the change.

The network hardware 228 can provide wired or wireless networking capabilities to the server(s) 106. The network hardware 228 can include or be incorporated into processors, ASICs, programmable circuits such as FPGAs, or in other ways.

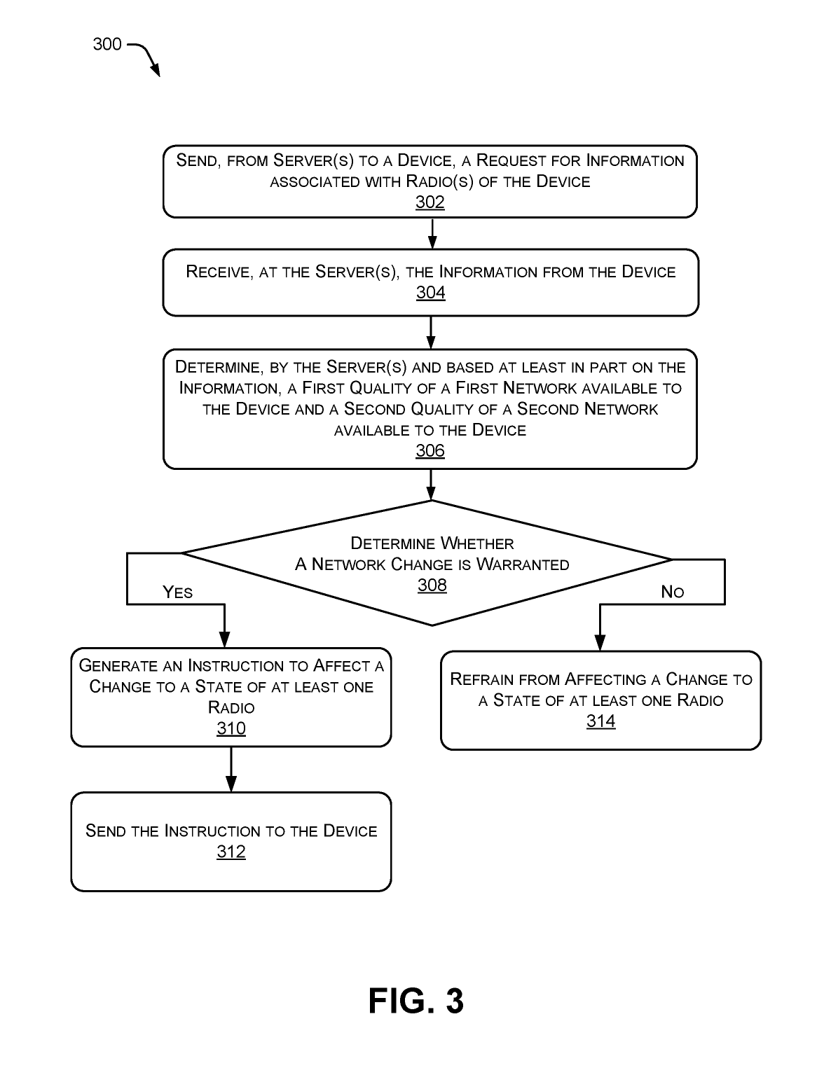

FIGS. 3-7 describe example processes for intelligent network routing. The example processes are described in the context of the environments of FIGS. 1 and 2, but are not limited to those environments.

The processes described above in association with FIGS. 3-7 can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functionalities or implement particular abstract data types. In other embodiments, hardware components perform one or more of the operations. Such hardware components can include or be incorporated into processors, ASICs, programmable circuits such as FPGAs, or in other ways. The order in which the operations are described is not intended to be construed as a limitation, and any number of the described operations and/or processes can be combined in any order and/or in parallel to implement the processes.

FIG. 3 illustrates an example process 300 for determining whether a network change is warranted based at least in part on information associated with one or more networks.

Block 302 illustrates sending, from server(s) to a device, a request for information associated with radio(s) of the device. As described above, the control module 242 can send requests to devices, such as device 102. In at least one example, the control module 242 can send a request for information associated with network(s) that are within range of the device 102. A network can be within range of the device 102 if the device 102 can access the network. In some examples, the control module 242 can send requests at a particular (configurable) frequency, after the lapse of a predetermined (configurable) amount of time, after an occurrence of an event, etc. In some examples, an event can correspond to a significant change in a characteristic of a network. For instance, as a non-limiting example, a change in signal strength of a network that exceeds a threshold in a predetermined period of time (e.g., fast degradation of network signal strength) can be an event. Or, in an additional and/or alternative non-limiting example, congestion of a network that meets or exceeds a threshold can be an event. Further, in yet another non-limiting example, a change in a geolocation of a device (e.g., device 102) can be an event. Additional and/or alternative events can be imagined.

Block 304 illustrates receiving, at the server(s), the information from the device. The control module 242 can receive information indicative of networks that are within range of the device 102. In some examples, the control module 242 can receive such information responsive to sending a request. Such information can include an identification of one or more cellular technologies (e.g., GSM, UMTS, LTE, 5G, etc.) that are available via one or more cellular networks, a signal-to-interference-plus-noise ratio associated with each of the one or more cellular networks, a latency associated with each of the one or more cellular networks, a packet-loss rate associated with each of the one or more cellular networks, a latency variance associated with each of the one or more cellular networks, etc. Additionally and/or alternatively, such information can include identities (e.g., SSID) of one or more non-cellular networks, backhaul associated with each of the one or more non-cellular networks, bandwidth associated with each of the one or more non-cellular networks, or network quality rating associated with each of the one or more non-cellular networks.

It should be noted that in some examples, block 302 can be optional. That is, in some examples, the server(s) 202 can receive information from the device 102 without sending a request for such information. For instance, in some examples, the control module 242 can receive information from the device 102 at a particular frequency, after a lapse in a predetermined amount of time, etc.

Block 306 illustrates determining, by the sever(s) and based at least in part on the information, a first quality of a first network available to the device and a second quality of a second network available to the device. Based on the information, the control module 242 can determine a quality associated with each network that is within range of the device 102. In some examples, the control module 242 can determine a value (or other indicator) that is representative of the quality of each network. For instance, a network that is determined to be of high quality—such to provide a positive user experience—can be associated with a value close to one, and a network that is determined to be of low quality—such to provide a negative user experience—can be associated with a value close to zero. While a scale of zero to one is used here, any scale, set of values, etc. can be used to represent a quality of a network, as described above.

Block 308 illustrates determining whether a network change is warranted. In at least one example, the control module 242 can compare networks and rank two or more networks based on corresponding quality. For instance, if the control module 242 determines that a cellular network is associated with a higher quality than a non-cellular network, the cellular network can be ranked higher than the non-cellular network. Or, if a non-cellular network is determined to be associated with a higher quality than a cellular network, the non-cellular network can be ranked higher than the cellular network. In some examples, the control module 242 can determine whether a network change is warranted based on the determined qualities and/or ranking based on the determined qualities.

In additional and/or alternative examples, the control module 242 can access additional information associated with the network(s) 202 that is not available to the device 102. For instance, the control module 242 can access data indicative of rate plan(s) associated with the device 102 (e.g., associated with a subscriber account for receiving services from the service provider 204), congestion of the network(s) 202, prioritization policies set by the network(s) 202, etc. In such examples, the control module 242 can determine which network to connect the device 102 based at least in part on the information received from the device 102 and/or the additional information. As described above, in at least one example, the control module 242 can utilize a data model, trained by a machine learning mechanism, to determine which network to route the device 102.

In at least one example, the control module 242 can determine whether the highest-ranking network corresponds to the network that the device 102 is currently connected to and/or a network requiring the same type of radio. If the device 102 is not connected to the highest-ranking network and/or utilizing the radio associated with the highest-ranking network, the control module 242 can determine that a network change is warranted. Block 310 illustrates generating an instruction to affect a change to a state of at least one radio. Based at least in part on determining that a network change is warranted, the control module 242 can generate an instruction to instruct the device 102 to change the state of at least one radio (e.g., cellular radio 116 and/or Wi-Fi radio 118), to effectuate a network change. The control module 242 can send the instruction to the device 102 to effectuate the change, as illustrated in block 312.

In at least one example, if the device 102 is connected to the highest-ranking network and/or is connected to a same type of radio that is required for the highest-ranking network, the control module 242 can determine that a network change is not warranted. Accordingly, the control module 242 can determine to refrain from affecting a change to a state of at least one radio, as illustrated in block 314.

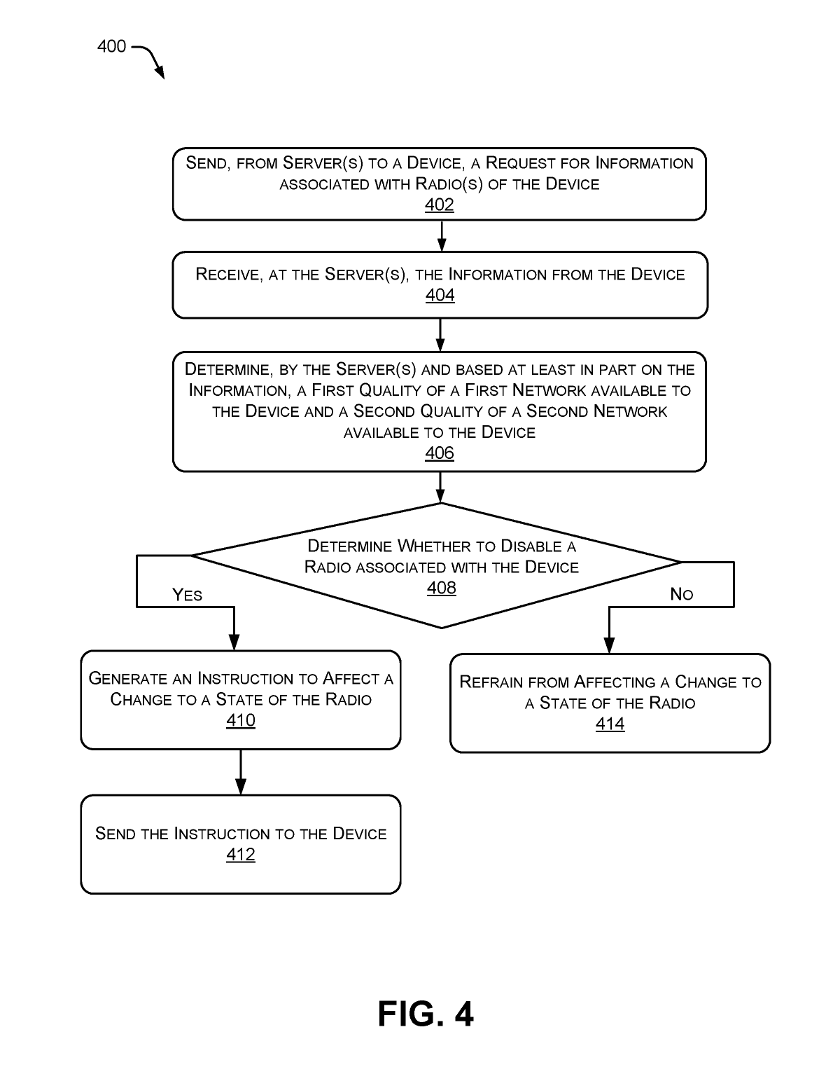

FIG. 4 illustrates an example process 400 for determining whether to disable a radio based at least in part on information associated with one or more networks.

Block 402 illustrates sending, from server(s) to a device, a request for information associated with radio(s) of the device. As described above, the control module 242 can send requests to devices, such as device 102. In at least one example, the control module 242 can send a request for information associated with network(s) that are within range of the device 102. A network can be within range of the device 102 if the device 102 can access the network. In some examples, the control module 242 can send requests at a particular (configurable) frequency, after the lapse of a predetermined (configurable) amount of time, after an occurrence of an event, etc.

Block 404 illustrates receiving, at the server(s), the information from the device. The control module 242 can receive information indicative of networks that are within range of the device 102. In some examples, the control module 242 can receive such information responsive to sending a request. Such information can include an identification of one or more cellular technologies (e.g., GSM, UMTS, LTE, 5G, etc.) that are available via one or more cellular networks, a signal-to-interference-plus-noise ratio associated with each of the one or more cellular networks, a latency associated with each of the one or more cellular networks, a packet-loss rate associated with each of the one or more cellular networks, a latency variance associated with each of the one or more cellular networks, etc. Additionally and/or alternatively, such information can include identities (e.g., SSID) of one or more non-cellular networks, backhaul associated with each of the one or more non-cellular networks, bandwidth associated with each of the one or more non-cellular networks, or network quality rating associated with each of the one or more non-cellular networks.

It should be noted that in some examples, block 402 can be optional. That is, in some examples, the server(s) 202 can receive information from the device 102 without sending a request for such information. For instance, in some examples, the control module 242 can receive information from the device 102 at a particular frequency, after a lapse in a predetermined amount of time, etc.

Block 406 illustrates determining, by the sever(s) and based at least in part on the information, a first quality of a first network available to the device and a second quality of a second network available to the device. Based on the information, the control module 242 can determine a quality associated with each network that is within range of the device 102. In some examples, the control module 242 can determine a value (or other indicator) that is representative of the quality of each network. For instance, a network that is determined to be of high quality—such to provide a positive user experience—can be associated with a value close to one, and a network that is determined to be of low quality—such to provide a negative user experience—can be associated with a value close to zero. While a scale of zero to one is used here, any scale, set of values, etc. can be used to represent a quality of a network, as described above.

Block 408 illustrates determining whether to disable a radio associated with the device. In at least one example, the control module 242 can compare the first quality and the second quality to determine whether a radio should be disabled. In such examples, the control module 242 can determine to disable a radio if the quality of the network is below a threshold and/or if the quality of the alternate network meets or exceeds a threshold. For instance, the control module 242 can determine to disable a non-cellular radio if the quality of the non-cellular network is below a threshold and/or the quality of the cellular network meets or exceeds a threshold. Or, in an additional and/or alternative example, the control module 242 can determine to disable a radio if the difference between the first quality and the second quality meets or exceeds a threshold.

In at least one example, the control module 242 can determine that the first quality is below a threshold and/or the second quality meets or exceeds a threshold. Accordingly, the control module 242 can determine to disable the radio associated with the first network. Or, the control module 242 can determine that the difference between the first quality and the second quality meets or exceeds a threshold. If the first quality is greater than the second quality, the control module 242 can determine to disable the radio associated with the second network. Or, if the second quality is greater than the first quality, the control module 242 can determine to disable the radio associated with the first network.

Block 410 illustrates generating an instruction to affect a change to a state of at least one radio. Based at least in part on determining to disable a radio associated with the device 102, the control module 242 can generate an instruction to instruct the device 102 to change the state of the radio to disable the radio. The control module 242 can send the instruction to the device 102 to effectuate the change, as illustrated in block 412.

Block 414 illustrates refraining from affecting a change to a state of the radio. Based at least in part on determining not to disable a radio associated with the device 102, the control module 242 can refrain from affecting a change to the state of the radio.

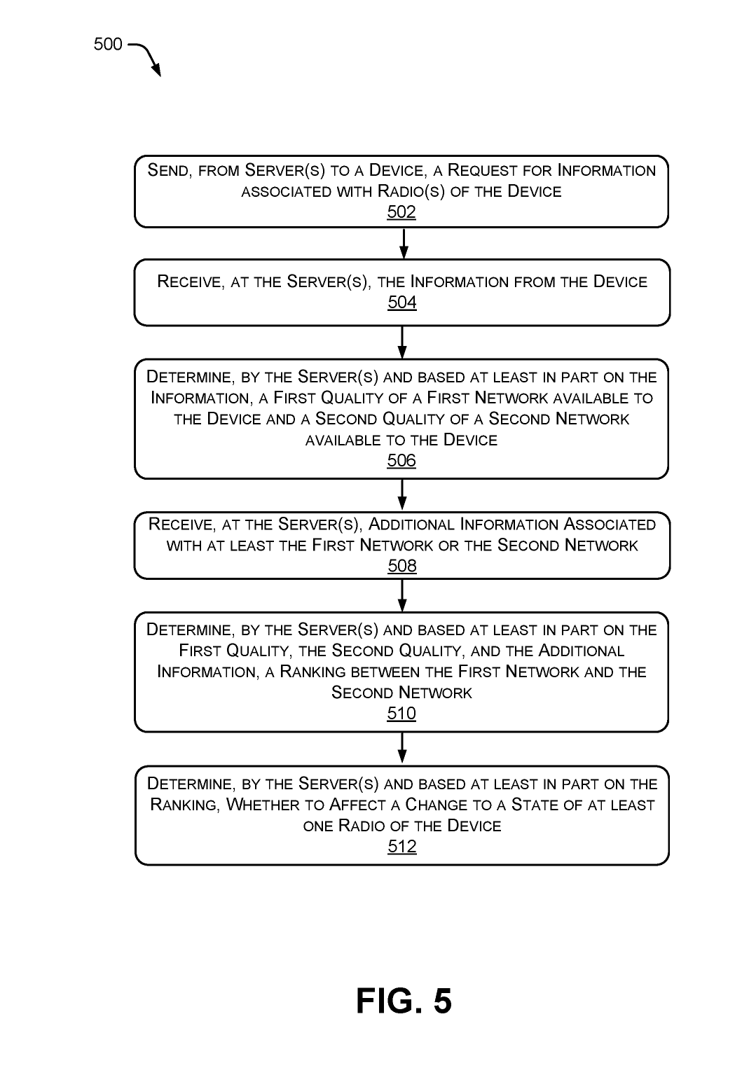

FIG. 5 illustrates an example process 500 for ranking two or more networks based at least in part on information associated with the two or more networks.

Block 502 illustrates sending, from server(s) to a device, a request for information associated with radio(s) of the device. As described above, the control module 242 can send requests to devices, such as device 102. In at least one example, the control module 242 can send a request for information associated with network(s) that are within range of the device 102. A network can be within range of the device 102 if the device 102 can access the network. In some examples, the control module 242 can send requests at a particular (configurable) frequency, after the lapse of a predetermined (configurable) amount of time, after an occurrence of an event, etc. In some examples, an event can correspond to a significant change in a characteristic of a network. For instance, as a non-limiting example, a change in signal strength of a network that exceeds a threshold in a predetermined period of time (e.g., fast degradation of network signal strength) can be an event. Or, in an additional and/or alternative non-limiting example, congestion of a network that meets or exceeds a threshold can be an event. Further, in yet another non-limiting example, a change in a geolocation of a device (e.g., device 102) can be an event. Additional and/or alternative events can be imagined.

Block 504 illustrates receiving, at the server(s), the information from the device. The control module 242 can receive information indicative of networks that are within range of the device 102. In some examples, the control module 242 can receive such information responsive to sending a request. Such information can include an identification of one or more cellular technologies (e.g., GSM, UMTS, LTE, 5G, etc.) that are available via one or more cellular networks, a signal-to-interference-plus-noise ratio associated with each of the one or more cellular networks, a latency associated with each of the one or more cellular networks, a packet-loss rate associated with each of the one or more cellular networks, a latency variance associated with each of the one or more cellular networks, etc. Additionally and/or alternatively, such information can include identities (e.g., SSID) of one or more non-cellular networks, backhaul associated with each of the one or more non-cellular networks, bandwidth associated with each of the one or more non-cellular networks, or network quality rating associated with each of the one or more non-cellular networks.

It should be noted that in some examples, block 502 can be optional. That is, in some examples, the server(s) 202 can receive information from the device 102 without sending a request for such information. For instance, in some examples, the control module 242 can receive information from the device 102 at a particular frequency, after a lapse in a predetermined amount of time, etc.

Block 506 illustrates determining, by the sever(s) and based at least in part on the information, a first quality of a first network available to the device and a second quality of a second network available to the device. Based on the information, the control module 242 can determine a quality associated with each network that is within range of the device 102. In some examples, the control module 242 can determine a value (or other indicator) that is representative of the quality of each network. For instance, a network that is determined to be of high quality—such to provide a positive user experience—can be associated with a value close to one, and a network that is determined to be of low quality—such to provide a negative user experience—can be associated with a value close to zero. While a scale of zero to one is used here, any scale, set of values, etc. can be used to represent a quality of a network, as described above.

Block 508 illustrates receiving, at the server(s), additional information associated with at least the first network or the second network. In some examples, the control module 242 can access additional information associated with the network(s) 202 that is not available to the device 102. For instance, the control module 242 can access data indicative of rate plan(s) associated with the device 102 (e.g., associated with a subscriber account for receiving services from the service provider 204), congestion of the network(s) 202, prioritization policies set by the network(s) 202, etc.

Block 510 illustrates determining, by the server(s) and based at least in part on the first quality, the second quality, and the additional information, a raking between the first network and the second network. In at least one example, the control module 242 can compare networks and rank two or more networks based on corresponding quality. In such an example, the control module 242 can leverage the first quality, the second quality, and the additional information to rank at least the first network and the second network. As described above, in at least one example, the control module 242 can utilize a data model, trained by a machine learning mechanism, to determine a ranking between the first quality and the second quality.

Block 512 illustrates determining, by the server(s) and based at least in part on the ranking, whether to affect a change to a state of at least one radio of the device. As described above, in at least one example, the control module 242 can determine whether the highest-ranking network corresponds to the network that the device 102 is currently connected to and/or a radio required to connect to the highest-ranking network is in a connected state. If the device 102 is not connected to the highest-ranking network and/or the radio required to connect to the highest-ranking network is in a disconnected state, the control module 242 can determine that a network change is warranted. Conversely, in at least one example, if the device 102 is connected to the highest-ranking network and/or the radio required to connect to the highest-ranking network is in a connected state, the control module 242 can determine that a network change is not warranted.

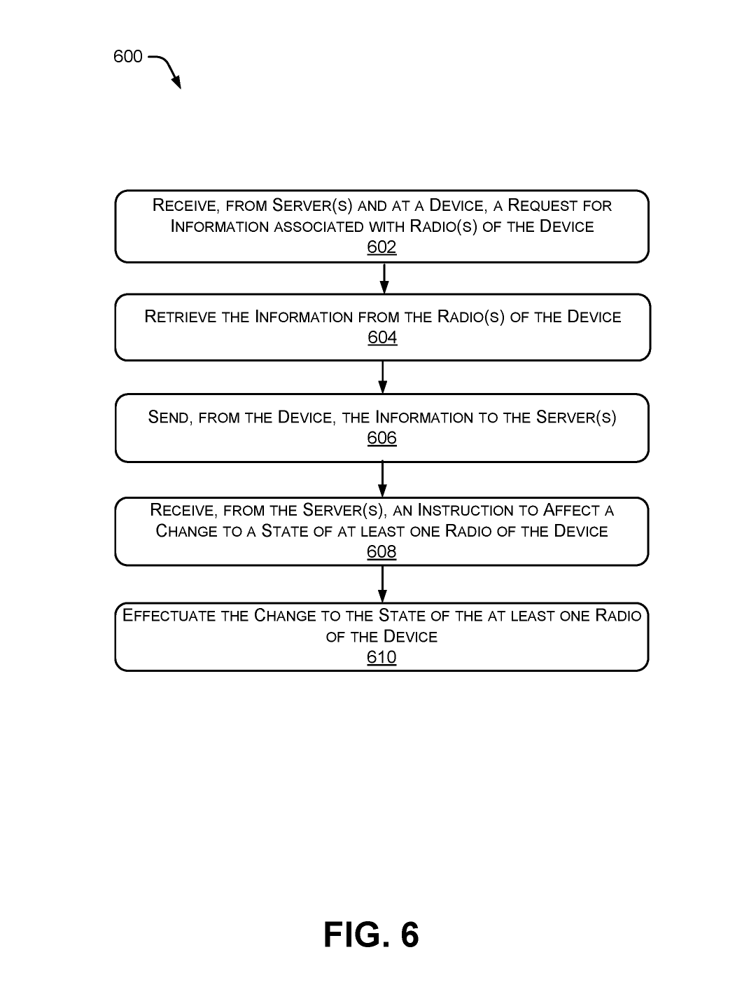

FIG. 6 illustrates an example process 600 for changing a state of one or more radios associated with the device.

Block 602 illustrates receiving, from server(s) and at a device, a request for information associated with radio(s) of the device. In at least one example, the network management module 114 can receive a request from server(s) 202 for information associated with networks that are available to the device 102.

Block 604 illustrates retrieving the information from the radios of the device. Responsive to receiving a request, the network management module 114 can request such information from radio(s) associated with the radio hardware 112. As described above, the radio hardware 112 can include a cellular radio 116 and a non-cellular radio (e.g., Wi-Fi radio 118). Accordingly, responsive to receiving a request, the network management module 114 can request such information from the cellular radio 116 and the Wi-Fi radio 118. In some examples, the network management module 114 can send a notification to the cellular radio 116 and/or the Wi-Fi radio 118 to affect a change from a disabled state to an enabled state. That is, if a radio has been disabled, the network management module 114 can ping the radio to enable the radio to scan for network(s) that are available to the device 102.

In at least one example, the cellular radio 116 can scan for one or more cellular networks that are within range of the device 102. In some examples, the cellular radio 116 can determine information associated with the one or more cellular networks. For instance, such information can include an identification of one or more cellular technologies (e.g., GSM, UMTS, LTE, 5G, etc.) that are available via the one or more cellular networks, a signal-to-interference-plus-noise ratio associated with each of the one or more cellular networks, a latency associated with each of the one or more cellular networks, a packet-loss rate associated with each of the one or more cellular networks, a latency variance associated with each of the one or more cellular networks, etc. In some examples, the cellular radio 116 can scan for one or more cellular networks and/or determine such information associated with the one or more cellular networks at a particular frequency, after a lapse of a predetermined period of time, responsive to a request (e.g., from the network management module 114), etc. The cellular radio 116 can provide such information to the network management module 114 as it is determined or in batches.

The Wi-Fi radio 118 can scan for one or more Wi-Fi networks (e.g., hotspots) that are within range of the device 102. In some examples, the Wi-Fi radio 118 can determine information associated with the one or more Wi-Fi networks. For instance, such information can include identities (e.g., SSID) of one or more Wi-Fi networks, backhaul associated with each of the one or more Wi-Fi networks, bandwidth associated with each of the one or more Wi-Fi networks, bandwidth associated with each of the one or more Wi-Fi networks, or network quality rating associated with each of the one or more Wi-Fi networks. In some examples, the cellular radio 116 can scan for one or more Wi-Fi networks at a particular frequency, after a lapse of a predetermined period of time, responsive to a request (e.g., from the network management module 114), etc. The Wi-Fi radio 118 can provide such information to the network management module 114 as it is determined or in batches.

It should be noted that in some examples, block 602 is optional. That is, in some examples, the network management module 114 can retrieve information associated with the radio hardware 112 without receiving a request. In other examples, the network management module 114 can receive such information at a particular frequency, after a lapse in a predetermined amount of time, etc.

Block 606 illustrates sending, from the device, the information to the server(s). The network management module 114 can receive the information from the radio(s) and can send such information to the server(s) 202.

Block 608 illustrates receiving, from the server(s), an instruction to affect a change to a state of at least one radio of the device. Responsive to sending the information to the one or more servers, the network management module 114 can receive an instruction from the one or more servers. The instruction can direct the network management module 114 to change the state of one or more of the radio(s) associated with the radio hardware 112.

As described above, the radios (e.g., cellular radio 116 and/or Wi-Fi radio 118) can be associated with different states. As described herein, a radio can be in a connected state, wherein the radio is connected to a corresponding network and capable of transmitting data via the corresponding network. For instance, when the cellular radio 116 is in a connected state, the device 102 can transmit data via the cellular network 106 and when the Wi-Fi radio 118 is in a connected state, the device 102 can transmit data via the Wi-Fi network 104.

Alternatively, a radio can be in a disconnected state, wherein the radio is not connected to a corresponding network. A radio in a disconnected state can gather information associated with network(s) that are within range of the radio, but may not send and/or receive data. For instance, when the cellular radio 116 is in a disconnected state, the device 102 may not transmit data via the cellular network 106, but may scan for available cellular network(s) and/or determine information associated with such cellular network(s). Or, when the Wi-Fi radio 118 is in a disconnected state, the device 102 may not transmit data via the Wi-Fi network 104, but may scan for available Wi-Fi network(s) and/or determine information associated with such Wi-Fi network(s).

In some examples, a radio can be in an enabled state. When a radio is in an enabled state it can additionally be in a connected state or disconnected state. Alternatively, in other examples, a radio can be in a disabled state. A radio in a disabled state may not gather information associated with network(s) that are within range of the radio (e.g., the radio is “off”). In at least one example, a radio can receive a notification (e.g., from the network management module 114) to change from a disabled state to an enabled state, which can cause the radio to change to the enabled state and enable the radio to gather information associated with network(s) that are within range of the radio.

In at least one example, the network management module 114 can receive an instruction to effect a change to at least one of the cellular radio 116 or the Wi-Fi radio 118. As described above, in some examples, if the cellular radio 116 is associated with a disconnected state and the Wi-Fi radio 118 is associated with a connected state (e.g., the device 102 is connected to a Wi-Fi network), an instruction can instruct the network management module 114 to affect a change to both the state of the cellular radio 116 (to a connected state) and the Wi-Fi radio 118 (to a disconnected state) to route the device 102 to a cellular network. Or, if the cellular radio 116 is associated with a connected state and the Wi-Fi radio 118 is associated with a disconnected state (e.g., the device 102 is connected to a cellular network), an instruction can instruct the network management module 114 to affect a change to both the state of the cellular radio 116 (to a disconnected state) and the Wi-Fi radio 118 (to a connected state) to route the device 102 to a Wi-Fi network.

As described above, in some examples, the instruction can instruct the network management module 114 to disable a radio. That is, the instruction can instruct the network management module 114 to change the state of a radio from enabled to disabled. In some examples, the instruction can instruct the network management module 114 to change the state of a radio from disabled to enabled.

Block 610 illustrates effectuating the change to the state of the at least one radio of the device. Based at least in part on receiving the instruction, the network management module 114 can modify the state of the at least one radio of the device 102 consistent with the instruction.

While the examples provided above in FIGS. 3-6 are described in the context of the server(s) 202 determining relative qualities of available networks and sending an instruction to affect state(s) of radio(s) associated with the device 102, in an alternate example, the network management module 114 can include computer-readable instructions that determine relative qualities of available networks and determine to which network a device should be connected to optimize user experience.

FIG. 7 illustrates an example process 700 for determining whether a network change is warranted based at least in part on information associated with one or more networks.

Block 702 illustrates receiving information associated with radio(s) of a device 102. The network management module 114 can receive information indicative of networks that are within range of the device 102. In some examples, the network management module 114 can receive such information responsive to sending a request. In other examples, the network management module 114 can receive such information at a particular frequency, after a lapse in a predetermined amount of time, etc.

Such information (e.g., from the cellular radio 116) can include an identification of one or more cellular technologies (e.g., GSM, UMTS, LTE, 5G, etc.) that are available via one or more cellular networks, a signal-to-interference-plus-noise ratio associated with each of the one or more cellular networks, a latency associated with each of the one or more cellular networks, a packet-loss rate associated with each of the one or more cellular networks, a latency variance associated with each of the one or more cellular networks, etc. Additionally and/or alternatively, such information (e.g., from the Wi-Fi radio 118) can include identities (e.g., SSID) of one or more non-cellular networks, backhaul associated with each of the one or more non-cellular networks, bandwidth associated with each of the one or more non-cellular networks, or network quality rating associated with each of the one or more non-cellular networks.

Block 704 illustrates determining, based at least in part on the information, a first quality of a first network available to the device and a second quality of a second network available to the device. Based on the information, the network management module 114 can determine a quality associated with each network that is within range of the device 102. In some examples, the network management module 114 can determine a value (or other indicator) that is representative of the quality of each network. For instance, a network that is determined to be of high quality—such to provide a positive user experience—can be associated with a value close to one, and a network that is determined to be of low quality—such to provide a negative user experience—can be associated with a value close to zero. While a scale of zero to one is used here, any scale, set of values, etc. can be used to represent a quality of a network, as described above.

Block 706 illustrates determining whether a network change is warranted. In at least one example, the network management module 114 can compare networks and rank two or more networks based on corresponding quality. For instance, if the network management module 114 determines that a cellular network is associated with a higher quality than a non-cellular network, the cellular network can be ranked higher than the non-cellular network. Or, if a non-cellular network is determined to be associated with a higher quality than a cellular network, the non-cellular network can be ranked higher than the cellular network. In some examples, the network management module 114 can determine whether a network change is warranted based on the determined qualities and/or ranking based on the determined qualities. In at least one example, the network management module 114 can utilize a data model, trained by a machine learning mechanism, to determine which network to route the device 102.

In at least one example, the network management module 114 can determine whether the highest-ranking network corresponds to the network that the device 102 is currently connected to and/or a network requiring the same type of radio. If the device 102 is not connected to the highest-ranking network and/or utilizing the radio associated with the highest-ranking network, the network management module 114 can determine that a network change is warranted. Block 708 illustrates affecting a change to a state of at least one radio. Based at least in part on determining that a network change is warranted, the network management module 114 can change the state of at least one radio (e.g., cellular radio 116 and/or Wi-Fi radio 118), to effectuate a network change. If the device 102 is connected to the highest-ranking network and/or the radio required to connect to the highest-ranking network is in a connected state, the network management module 114 can determine that a network change is not warranted. Accordingly, the network management module 114 can refrain from affecting a change to a state of at least one radio, as illustrated in block 710.

Although the subject matter has been described in language specific to structural data items and/or methodological acts, it is to be understood that the subject matter defined in the appended claims is not necessarily limited to the specific data items or acts described. Rather, the specific data items and acts are disclosed as exemplary forms of implementing the claims.

1. A system comprising one or more servers associated with a service provider, the one or more servers including:
one or more processors; and
one or more computer-readable media storing instructions executable by the one or more processors, wherein the instructions program the one or more processors to:
send, to a device utilizing a non-cellular network, a request for first information associated with a first radio associated with the non-cellular network, and second information associated with a second radio associated with a cellular network, the second information comprising at least a latency variance associated with the cellular network;
receive, from the device, the first information and the second information;
determine, based at least in part on the first information and the second information, that a first quality of the cellular network is greater than a second quality of the non-cellular network; and
send, to the device, an instruction to establish a connection with the cellular network to cause one or more future data transmissions to be routed through the cellular network instead of the non-cellular network, the instruction based at least in part on determining that the first quality of the cellular network is greater than the second quality of the non-cellular network.

2. The system as claim 1 recites, wherein the first information includes at least one of an identity of the non-cellular network, backhaul associated with the non-cellular network, bandwidth associated with the non-cellular network, or network quality associated with the non-cellular network.

3. The system as claim 1 recites, wherein the second information further includes at least one of a signal-to-interference-plus-noise ratio associated with the cellular network, or a packet-loss rate associated with the cellular network.

4. The system as claim 1 recites, wherein the instructions program the one or more processors further to determine at least one of congestion associated with at least the cellular network or a prioritization policy associated with the cellular network.

5. The system as claim 4 recites, wherein the instructions program the one or more processors further to rank the cellular network and the non-cellular network based at least in part on one or more of the first quality, the second quality, a cost, the congestion, or the prioritization policy, the cellular network ranking higher than the non-cellular network.

6. The system as claim 1 recites, wherein the instructions program the one or more processors further to disable the first radio.

7. The system as claim 1 recites, wherein the instructions program the one or more processors further to:
determine a lapse of a configurable period of time; and
send the request to the device based on the lapse of the configurable period of time.

8. The system as claim 1 recites, wherein the instructions program the one or more processors further to:
determine an occurrence of an event; and
send the request to the device based on the occurrence of the event.

9. A computer-implemented method performed by one or more servers of a service provider, the computer-implemented method comprising:
sending, to a device utilizing a non-cellular network, a request for first information associated with a first radio associated with the non-cellular network and second information associated with a second radio associated with a cellular network, the second information comprising at least a latency variance associated with the cellular network;
receiving, from the device, the first information and the second information;
determining, based at least in part on the first information and the second information, to change a state of at least one of the first radio or the second radio, the determining including determining, based at least in part on the first information, to change the state of the first radio to a disabled state; and
sending, to the device, an instruction to affect the change to the state of at least one of the first radio or the second radio.

10. The computer-implemented method as claim 9 recites, further comprising:
determining, based at least in part on the first information and the second information, that a first quality of the cellular network is greater than a second quality of the non-cellular network;
determining to change the state of the first radio from a connected state to a disconnected state; and
determining to change the state of the second radio from the disconnected state to the connected state.

11. (canceled)

12. The computer-implemented method as claim 9 recites, further comprising:
determining, based at least in part on the first information and the second information, that a first quality of the cellular network is less than a second quality of the non-cellular network; and
determining to change the state of the second radio to a disabled state.

13. The computer-implemented method as claim 9 recites, wherein the first information includes at least one of an identity of the non-cellular network, backhaul associated with the non-cellular network, bandwidth associated with the non-cellular network, or network quality associated with the non-cellular network.

14. The computer-implemented method as claim 9 recites, wherein the second information further includes at least one of a signal-to-interference-plus-noise ratio associated with the cellular network, or a packet-loss rate associated with the cellular network.

15. The computer-implemented method as claim 9 recites, wherein sending the request for the first information and the second information comprises sending the request to an application on the device and causing the application to retrieve the first information from the first radio and the second information from the second radio.

16. A computer-implemented method performed by an application executing on a device connected to a non-cellular network, the computer-implemented method comprising:
receiving, from one or more servers, a request for information associated with a plurality of radios associated with the device;
receiving first information associated with a first radio of the plurality of radios, the first radio configured to access the non-cellular network;
receiving second information associated with a second radio of the plurality of radios, the second radio configured to access a cellular network;
sending, to the one or more servers, the first information and the second information, the second information comprising at least a latency variance associated with the cellular network;
receiving, from the one or more servers, one or more instructions to modify a state of at least one of the first radio or the second radio, wherein the one or more instructions are based on the first information and the second information, and include an instruction to modify the state of the first radio from a connected state to a disabled state; and
modifying the state of the at least one of the first radio or the second radio.

17. The computer-implemented method as claim 16 recites, wherein the first information includes at least one of an identity of the non-cellular network, backhaul associated with the non-cellular network, bandwidth associated with the non-cellular network, or network quality associated with the non-cellular network.

18. The computer-implemented method as claim 16 recites, wherein the second information further includes at least one of a signal-to-interference-plus-noise ratio associated with the cellular network, or packet-loss rate associated with the cellular network.

19. The computer-implemented method as claim 16 recites, wherein the one or more instructions include:
another instruction to modify the state of the second radio from the disconnected state to the connected state.

20. The computer-implemented method as claim 16 recites, wherein the one or more instructions include another instruction to change the state of the second radio to the disabled state.

21. The system as claim 8 recites, wherein determining the occurrence of the event comprises at least one of:
determining that a change in signal strength of the non-cellular network exceeds a threshold in a predetermined period of time; and
determining a change in a geolocation of the device.
